(19) United States
(12) Patent Application Publication
(10) Pub. No.: US 2017/0088236 A1
(43) Pub. Date: Mar. 30, 2017

(54) TRANSVERSE METACENTER HEIGHT ESTIMATION DEVICE AND TRANSVERSE METACENTER HEIGHT ESTIMATION METHOD

(71) Applicants: FLUID TECHNO CO., LTD., Sasebo-shi, Nagasaki (JP); JAPAN FISHERIES RESEARCH AND EDUCATION AGENCY, Yokohama-shi, Kanagawa (JP); FURUNO ELECTRIC CO., LTD., Hyogo (JP)

(72) Inventors: Masahiro TAMASHIMA, Sasebo-shi, Nagasaki (JP); Daisuke TERADA, Kamisu-shi, Ibaraki (JP); Akihiko MATSUDA, Kamisu-shi, Ibaraki (JP); Hitoshi MAENO, Hyogo (JP); Koji HAYASHI, Hyogo (JP)

(21) Appl. No.: 15/310,850

(22) PCT Filed: May 20, 2015
(86) PCT No.: PCT/JP2015/064429

§ 371 Date: Nov. 14, 2016

(30) Foreign Application Priority Data
May 20, 2014 (JP) 2014-104786

(51) Int. Cl. B63B 9/08; G01C 21/20; G01C 5/00

(52) U.S. Cl. CPC B63B 9/08; G01C 5/00; G01C 21/203

(57) ABSTRACT

Provided is a transverse metacenter height estimation device that includes: a history storage means for storing time sequence data of the roll angle of a hull; and a transverse metacenter height estimation means that estimates the transverse metacenter height of the hull on the basis of the time sequence data of the roll angle of the hull, such data stored by the history storing means. The transverse metacenter height estimation device is characterized in that the transverse metacenter height estimation means first calculates a roll natural frequency on the basis of the time sequence data of the roll angle of the hull, sets the calculated roll natural frequency as an observation model, carries out state estimation on the basis of a normal state spatial model in which the transverse metacenter height and the gyration radius of the hull are used as state variables, and thereby estimates the transverse metacenter height.

### INCORPORATION BY REFERENCE

The present application claims priority from Japanese Patent Application No. 2014-104786 filed on May 20, 2014, the contents of which are hereby incorporated by reference.

### TECHNICAL FIELD

The present invention relates to a transverse metacenter height estimation device and a transverse metacenter height estimation method.

### BACKGROUND ART

Conventionally, with respect to a vessel running on randomly moving waves, it is important to appropriately grasp hull motion data, hull state data, and sea conditions from a safety point of view. The hull motion data are the data related to the motion of the hull, such as a displacement and an acceleration of the hull. Further, the hull state data are the data related to the state of the hull, such as a draft, a drainage volume, and a transverse metacenter height (hereinafter, also referred to as “GM”) of the hull. Further, the sea conditions are the information related to the sea phenomena, such as a wave height, a wave cycle, and a wave direction of the wave on the area where the vessel is running.

Conventionally, it is common that the hull motion data of these pieces of information are kinetically obtained on the basis of the previously set hull state data and the sea conditions provided from an information providing institution such as the Meteorological Agency.

However, in this method, it is impossible to grasp the hull motion data and the hull state data appropriately. This is because the sea conditions provided from an information providing institution such as the Meteorological Agency have a large amount of information on a wide area of water instead of a local area of water in which the vessel is currently running, and have a low accuracy.

To address this issue, in recent years, a method is reported in which hull motion data are measured with various devices mounted on a vessel, the measured hull motion data, which are unsteady time-series data, are subjected to statistic processing in real time, so that the hull state data and the sea conditions are statistically estimated (for example, see Non-Patent Document 1).

Non-Patent Document 1 discloses a technique in which the sea conditions are estimated by analyzing the hull motion data, which are unsteady time-series data, by using the Time Varying Coefficient Vector AR (TVVAR).

### CITATION LIST

### Non-Patent Literature

Non-Patent Literature 1: Tsugikiyo Hirayama, Toshio Iseki, Shigesuke Ishida, “Real-Time Detection Method of Encountering Ocean Waves and Recent Results”, The Japan Society of Naval Architects and Ocean Engineers, December 2003, pp. 74-96.

### SUMMARY OF THE INVENTION

### Technical Problems

As described in the above conventional art, the hull state data are estimated on the basis of the hull motion data as the unsteady time-series data. As an example, “GM”, which is one of the hull state data, is estimated on the basis of “time-series data of a rolling angle”, which is one of the hull motion data. Specifically, the rolling natural frequency is first estimated on the basis of the time-series data of the rolling angle, and the GM is then estimated on the basis of the estimated rolling natural frequency.

However, by the conventional estimation method, it is impossible to accurately estimate the GM. This is because when the GM is estimated on the basis of the rolling natural frequency, an approximation formula as shown in Equation (1) is used.

$$\begin{matrix}[ Mathematical Expression 1 ] & \\ T = \frac{2 CB}{\sqrt{GM}} & ( 1 ) \\ C = 0.373 + 0.023 ( \frac{B}{d} ) - 0.043 ( \frac{L}{100} ) & \end{matrix}$$

In Equation (1), T is a rolling natural period, C is an experimental constant, B is a width of a ship, d is a draft of the ship, and L is a length of the ship. In Equation (1), C is used as a constant, where C indicates a different value depending on loading conditions and the like. For this reason, the accuracy of the estimated value of GM is accordingly low.

The present invention has been made in view of the above issue, and an object of the invention is to provide a transverse metacenter height estimation device and a transverse metacenter height estimation method which enable highly accurate estimation of the transverse metacenter height.

### Solution to Problems

In order to achieve the above object, an transverse metacenter height estimation device according to the present invention includes: a time history memory unit that stores time-series data of a rolling angle of a hull; and a transverse metacenter height estimation unit that estimates a transverse metacenter height of the hull based on the time-series data of the rolling angle of the hull stored in the time history memory unit. The transverse metacenter height estimation unit first calculates a rolling natural frequency based on the time-series data of the rolling angle of the hull, and then estimates, while using the calculated rolling natural frequency as an observation model, the transverse metacenter height by performing state estimation based on a general state-space model in which the transverse metacenter height and a radius of gyration of the hull are state variables.

### Advantageous Effects of Invention

The present invention enables estimation of a transverse metacenter height with high accuracy.

### BRIEF DESCRIPTION OF THE DRAWINGS

FIG. 1 is a diagram showing an example of a hardware configuration of a sea phenomena estimation system including a transverse metacenter height estimation device according to an embodiment.

FIG. 2 is a diagram showing a functional configuration example of the sea phenomena estimation system including a transverse metacenter height estimation device according to the embodiment.

FIG. 3 is a flowchart showing an example of a control logic of the sea phenomena estimation system including a transverse metacenter height estimation device according to the embodiment.

### DESCRIPTION OF EMBODIMENT

Hereinafter, an embodiment according to the present invention will be described.

### Hardware Configuration of System

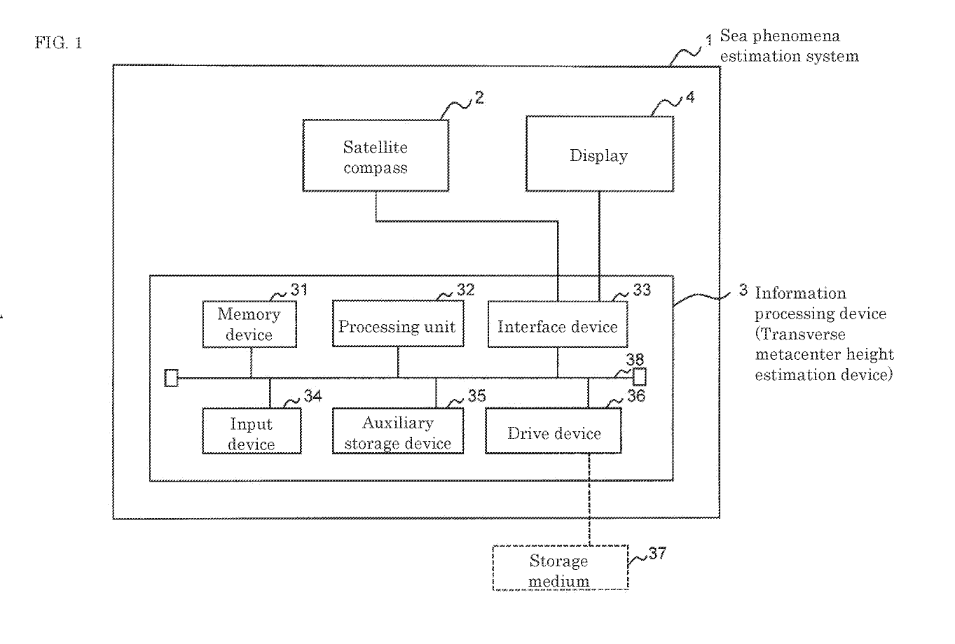

FIG. 1 is a diagram showing an example of a hardware configuration of a sea phenomena estimation system including a transverse metacenter height estimation device according to the embodiment.

A sea phenomena estimation system 1 shown in FIG. 1 is equipped with a satellite compass 2, an information processing device (transverse metacenter height estimation device) 3, and a display 4. The sea phenomena estimation system 1 is mounted in a hull of a vessel.

The satellite compass (GPS compass) 2 is a device having a function as a direction sensor which calculates the direction of the hull on the basis of the relationship between relative positions of two GPS antennas attached in a bow direction of the hull. The satellite compass 2 has also a function as a motion in wave sensor which can measure transverse motion in wave (rolling), longitudinal motion in wave (pitching), and vertical motion in wave (heaving) of the hull. Note that a gyro sensor may be used instead of the satellite compass 2.

The information processing device 3 is a computer device which includes a memory device 31, a processing unit 32, an interface device 33, an input device 34, an auxiliary storage device 35, and a drive device 36 which are each connected to one another through a bus 38. The information processing device 3 estimates the transverse metacenter height on the basis of information measured by the satellite compass 2. Further, the information processing device 3 estimates the sea conditions on the basis of the estimated value of the transverse metacenter height and the like. The information processing device 3 corresponds to a “transverse metacenter height estimation device” of the claims. Note that the information processing device 3 and the display 4 to be described later may be integrated with the satellite compass 2.

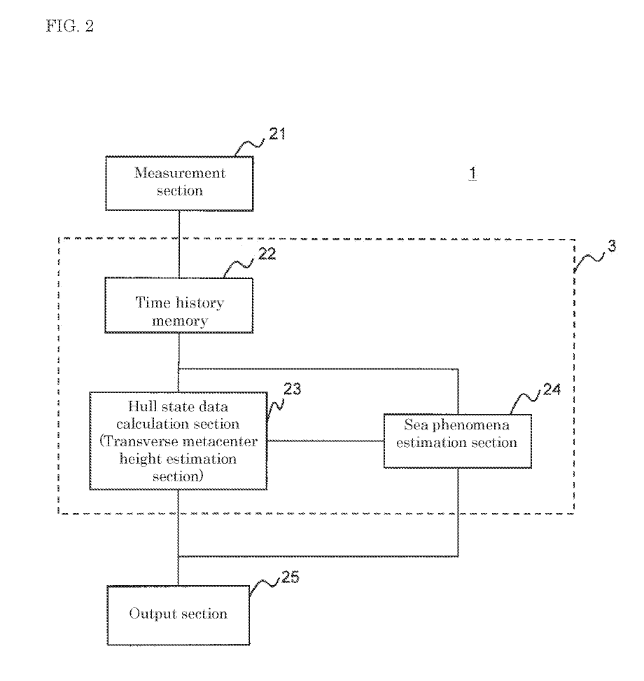

The memory device 31 is a storage device such as a random access memory (RAM) which reads out, at a time of start-up of the information processing device 3, a program (a program which realizes a hull state data calculation section 23 and a sea phenomena estimation section 24 of FIG. 2) and the like stored in the auxiliary storage device 35. The memory device 31 stores also a file, data, and the like necessary to execute a program.

The processing unit 32 is a processing unit such as a central processing unit (CPU) which executes a program stored in the memory device 31. The interface device 33 is an interface device to connect to an external device such as the satellite compass 2 and the display 4. The input device 34 is an input device (for example, a keyboard or a mouse) to provide a user interface.

The auxiliary storage device 35 is a storage device such as a hard disk drive (HDD) which stores a program, a file, data, and the like. The auxiliary storage device 35 stores a program and the like which realize a function of the hull state data calculation section 23 and the sea phenomena estimation section 24 of FIG. 2.

The drive device 36 is a device which reads out a program (for example, a program which realizes a function of the hull state data calculation section 23 and the sea phenomena estimation section 24 of FIG. 2) stored in a storage medium 37. A program read out by the drive device 36 is installed in the auxiliary storage device 35. The storage medium 37 is a storage medium such as a universal serial bus (USB) memory and an SD memory card, and the storage medium store the above program or the like.

The display 4 is an output device which outputs, on a screen, output data generated by the information processing device 3, for example, the sea conditions.

### Functional Configuration of System

FIG. 2 is a diagram showing a functional configuration example of the sea phenomena estimation system including a transverse metacenter height estimation device according to the present embodiment. Note that, in the following description, components similar to the components of FIG. 1 are assigned the same reference numerals, and redundant description is appropriately omitted.

The sea phenomena estimation system 1 shown in FIG. 2 has a measurement section 21, a time history memory 22, a hull state data calculation section (transverse metacenter height estimation section) 23, the sea phenomena estimation section 24, and an output section 25. The sea phenomena estimation system 1 is mounted on a vessel. Note that the information processing device 3 realizes respective functions of the time history memory 22, the hull state data calculation section 23, and the sea phenomena estimation section 24.

The measurement section 21 is a measurement unit which measures hull motion data of a vessel on which the sea phenomena estimation system 1 is mounted. Here, the hull motion data means the data related to the motion of the hull such as a rolling angle, a pitching angle, a displacement of heaving, and the like of the hull. Note that it is also possible to use angular velocities of rolling and pitching and an acceleration of heaving of the hull. The measurement section 21 is realized by the satellite compass 2 of FIG. 1 or a gyro sensor.

The time history memory 22 is a time history storage unit which stores a time history of the hull motion data measured by the measurement section 21. The time history memory 22 stores time-series data of the hull motion data in a predetermined period from past to now. The time history memory 22 is realized by the memory device 31 and the like of FIG. 1. Note that an input source of the history of the hull motion data is not limited to the measurement section 21. For example, it is also possible that another information processing device storing a history of the hull motion data is used as the input source.

The hull state data calculation section 23 is a hull state data calculation unit which calculates the hull state data on the basis of the history of the hull motion data stored in the time history memory 22 in a predetermined period. Here, the hull state data means the data related to the state of the hull such as a draft, a drainage volume, and a GM. The hull state data calculation section 23 is realized by the processing unit 32 and the like of FIG. 1. The hull state data calculation section 23 corresponds to a “transverse metacenter height estimation unit” of the claims.

The sea phenomena estimation section 24 is a sea phenomena estimation unit which estimates local sea conditions in the water in which the vessel equipped with the sea phenomena estimation system 1 is running, on the basis of the history of the hull motion data stored in the time history memory 22 and the hull state data calculated by the hull state data calculation section 23. Here, the sea conditions means the information related to the sea phenomena such as a wave height, a wave cycle, a wave direction, and the like of the wave in the area in which the vessel is running.

The sea phenomena estimation section 24 is realized by the processing unit 32 and the like of FIG. 1.

The output section 25 is an output unit which outputs the hull state data calculated by the hull state data calculation section 23 and the sea conditions estimated by the sea phenomena estimation section 24. The output section 25 is realized by the display 4 and the like of FIG. 1.

With the configuration described above, in the sea phenomena estimation system 1 according to the present embodiment, the hull state data calculation section (transverse metacenter height estimation section) 23 owned by the information processing device 3 estimates the transverse metacenter height on the basis of the hull motion data measured by the measurement section 21, and then the sea phenomena estimation section 24 estimates the sea conditions. An output section 25 outputs the estimated transverse metacenter height and the estimated sea conditions.

### Control Logic of System

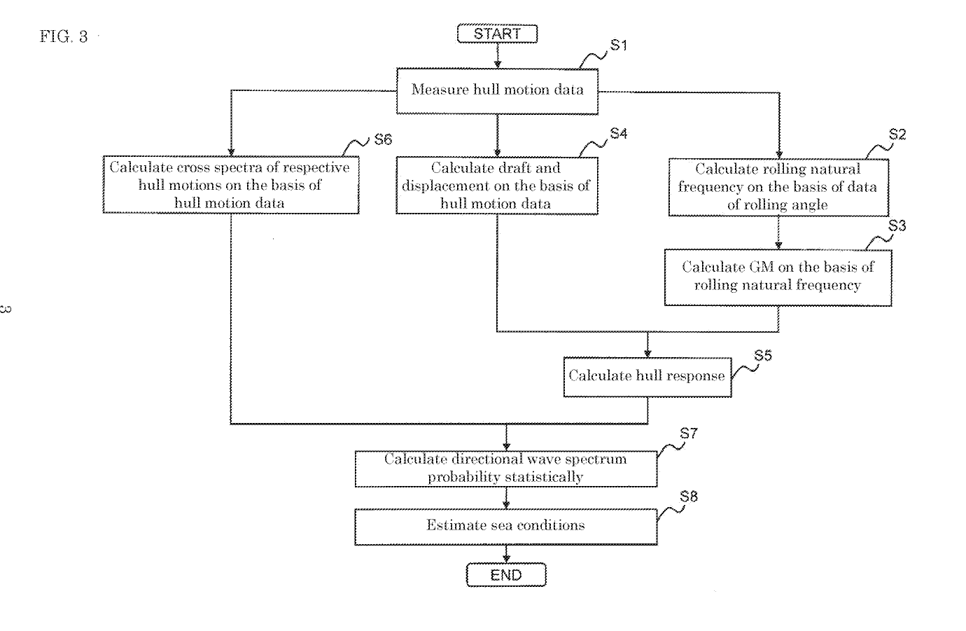

FIG. 3 is a flowchart showing a control logic of the sea phenomena estimation system including a transverse metacenter height estimation device according to the present embodiment.

The sea phenomena estimation system 1 repeatedly estimates the sea conditions by repeatedly performing a control logic of a series of steps S1 to S8 shown in FIG. 3. In particular, the sea phenomena estimation system 1 estimates the transverse metacenter height by repeatedly performing the process of steps S1 to S3. Note that a description will be given below, appropriately with reference to FIG. 2.

First, in step S1, the measurement section 21 measures the hull motion data (step S1). Specifically, the data of the rolling angle and the pitching angle and the displacement of heaving of the hull. Step S1 may be successively performed in the process of repeating the series of steps S1 to S8, or may be repeatedly performed, by a batch process or the like, as a process independent from steps S2 to S8.

Note that by repeatedly performing the process of step S1 shown in FIG. 3, the time-series data of the rolling angle, the pitching angle, and the displacement of heaving in a predetermined period from past to now, in other words, the data of the angles and the like at respective times are stored in the time history memory 22. Then, the process goes to respective processes of steps S2, S4, and S6.

Next, in step S2, the hull state data calculation section 23 calculates (estimates) a rolling natural frequency on the basis of the time-series data of the rolling angle (step S2). Although the process of step S2 is a known technique, an example of the process will be described below.

Specifically, a second order linear probability dynamic model (see Equation (2) below) about time-series data x(t) of rolling is considered. Note that, in Equation (2), a₁(=2α) is a damping coefficient and a₂(=ω²) is a square of a natural angular frequency ω. The term u(t) represents an external force term dealt as a stochastic process and has a finite dispersion. However, the term u(t) does not need whiteness.

[Mathematical Expression 2]

x″(t)+a₁x′(t)+a₂x(t)=u(t) (2)

Further, the external force term u(t) in Equation (2) is expressed by an m order continuous auto regression model shown in Equation (3) below. Note that, in Equation (3), bᵢ(i=1, . . . , m) is a coefficient of the model, and v(t) is a normal white noise, where the average is 0, and the dispersion is σ².

$$\begin{matrix}[ Mathematical Expression 3 ] & \\ {u}^{( m )} ( t ) + {\sum }_{i = 1}^{m} {b}_{i} {u}^{( m - i )} ( t ) = v ( t ) & ( 3 )\end{matrix}$$

By substituting Equation (2) into Equation (3), a whitened (m+2) order continuous auto regression model shown in Equation (4) is obtained. Note that cᵢ (where i=1, . . . , m+2) in Equation (4) is a coefficient of the model.

$$\begin{matrix}[ Mathematical Expression 4 ] & \\ {x}^{( m + 2 )} ( t ) + {\sum }_{i = 1}^{m + 2} {c}_{i} {u}^{( m + 2 - i )} ( t ) = v ( t ) & ( 4 )\end{matrix}$$

Equation (4) is expressed as Equation (5) below in a vector form.

$$\begin{matrix}[ Mathematical Expression 5 ] & \\ {x}^{′} ( t ) = Ax ( t ) + Bv ( t ) \\ where \\ \{ \begin{matrix}x ( t ) = {( \begin{matrix}x ( t ) & {x}^{′} ( t ) & {x}^{″} ( t ) & … & {x}^{( m + 1 )}\end{matrix} )}^{T} \\ A = ( \begin{matrix}0 & 1 & 0 & … & 0 \\ 0 & 0 & 1 & 0 & ⋮ \\ ⋮ & ⋮ & ⋱ & ⋱ & 0 \\ 0 & 0 & … & 0 & 1 \\ - {C}_{m + 2} & - {C}_{m + 1} & … & - {C}_{2} & - {C}_{1}\end{matrix} ) \\ B = {I}_{( m + 2 ) \times ( m + 2 )} , \\ v ( t ) = {( \begin{matrix}0 & 0 & … & 0 & v ( t )\end{matrix} )}^{T}\end{matrix} & ( 5 )\end{matrix}$$

Equation (5) is dealt as a system model of a state space model after being discretized. Further, in order to simultaneously estimate the unknown coefficients cᵢ (where i=1, . . . , m+2), a state vector of the state space model is considered with the above-described unknown coefficients aᵢ and bᵢ included therein, and the model is then extended into a auto-organizing state space model; then, the state estimation and the unknown coefficients are simultaneously estimated by using an Ensemble Kalman Filter. The state estimation by using the Ensemble Kalman Filter is a known technique and is thus not described here.

By the procedure described above, in step S2, the rolling natural frequency is calculated (estimated) on the basis of the time-series data of the rolling angle stored in the time history memory 22. Note that the rolling natural frequency may be calculated by a method different from the above method. For example, the rolling natural frequency may be calculated by using a discretized auto regression model.

After that, in step S3, the hull state data calculation section 23 calculates (estimates) the GM on the basis of the rolling natural frequency calculated in step S2 (step S3).

In step S3, in a non-linear observation model in which the rolling natural frequency (or a rolling natural period, which is the inverse) calculated in step S2 is used as observed data and in which the GM and the radius of gyration are the state variables, it is assumed that the state variables fluctuate slightly with time, and this is considered as the system model; thus, a general state-space model analysis is performed to simultaneously estimate the GM and the radius of gyration.

That is, the relationship represented by Equation (6) below holds between the rolling natural frequency f (=ω/2π) calculated in step S2 and the GM. Note that, in Equation (6), T is the rolling natural period (unit: s), f is the rolling natural frequency (unit: Hz), k is the radius of gyration (unit: m), and g is the gravitational acceleration (unit: m/s²). In Equation (6), GM (unit: m) and k are unknown.

$$\begin{matrix}[ Mathematical Expression 6 ] & \\ T = \frac{1}{f} = \frac{2 π k}{\sqrt{gGM}} & ( 6 )\end{matrix}$$

Then, in step S3, the state space model is considered in which two unknowns of the GM and the radius of gyration k are the state variables. That is, a non-linear observation model is considered in which the rolling natural period Tn is observed from the estimated amount of the states of GMn and kn at time n. It is assumed that the state variables fluctuate slightly with time, and this is considered as the system model. Thus, the general state-space model represented by Equation (7) below is configured. Note that, in Equation (7), vn is a system noise, and wn is an observation noise. For the sake of simplicity, the noises are considered as normal white noises.

$$\begin{matrix}[ Mathematical Expression 7 ] & \\ \{ \begin{matrix}{x}_{n} = {x}_{n - 1} + {v}_{n} \\ {T}_{n} = h ( {x}_{n} , {w}_{n} )\end{matrix} \\ where \\ \{ \begin{matrix}{x}_{n} = {( {GM}_{n} {k}_{n} )}^{T} \\ {v}_{n} = {( {v}_{1 , n} {v}_{2 , n} )}^{T}\end{matrix} & ( 7 )\end{matrix}$$

In step S3, state estimation is performed by using a Monte Carlo filter, which is a type of particle filters, on the basis of the general state-space model represented by Equation (7). Note that the state estimation by using a Monte Carlo filter is a known method and is not described here.

By the process of steps S2 and S3 described above, the hull state data calculation section 23 calculates (estimates) the GM of the hull in real time by analyzing the time-series data of the rolling angle in a predetermined period stored in the time history memory 22. By this method, it is possible to grasp the change in the position of the center of gravity in a loading state and grasp a degree of motion of the vessel.

Further, because no approximation is used to estimate GM, it is possible to obtain a generally stable estimation result of GM. For example, in the case that GM of a vessel at the time of design was 0.52, GM was calculated to be about 0.68 by the conventional method represented by Equation (1), but GM was estimated to be in the range of 0.48 to 0.54 by the method according to the present embodiment. Therefore, the method according to the present embodiment enables GM to be estimated with high accuracy. Note that in the above Equation (7), the equation may be made to include a valuable older than the previous timing (for example, Xₙ₋₂).

Returning to FIG. 3, if the process goes from step S1 to step S4, the hull state data calculation section 23 calculates the draft and the drainage volume of the hull by analyzing the time-series data of the displacement of heaving stored in the time history memory 22 in step S1 (step S4). For example, the draft is calculated on the basis of the time-series data of the displacement of heaving, an installation height of the GPS antennas (corresponding to the measurement section 21 of FIG. 1), an inclination angle of the vessel in the longitudinal direction, and the like. Then, the drainage volume is further calculated on the basis of the calculated draft.

If the process goes from steps S3 and S4 to step S5, the sea phenomena estimation section 24 calculates a current hull response of the hull on the basis of the hull state data calculated in step S2 (step S5).

As the process of step S5, there are two possible methods described below, and any one of them is used. In the first method, a hull response function is previously calculated to make a data base by using as parameters the hull state data (the draft and GM), a vessel speed, and sea phenomena (a wave height, a wave cycle, and a wave direction) which is to be an input; and the hull response function corresponding to the current states is then obtained by an interpolation calculation. In the second method, the hull response function is calculated on the basis of a calculation formula, with the current state of the hull and the sea phenomena being used as inputs. In any of the methods, the sea phenomena are an unknown to be obtained below and are also a term necessary to calculate the hull response function. The most appropriate response function is selected in real time as a non-linear problem by using an iteration method. Note that the response function is here a function indicating how the hull responds (moves) when the hull receives waves with a regular wavelength from any given direction, and the parameters of the function are a wave direction, a wave length, and the like.

In the process of step S5, the most appropriate hull response function is selected in real time, depending on the current hull motions (the pitching, the rolling, and the heaving) and the vessel speed measured by the measurement section 21 (the satellite compass 2). By this process, even on the actual sea in which the vessel speed changes from moment to moment, the most appropriate response function of the hull can be obtained. As a result, it is also possible to improve the accuracy of the estimation of the sea conditions to be described later.

Further, if the process goes from step S1 to step S6, the hull state data calculation section 23 calculates cross spectra of the respective hull motions (the rolling, the pitching, and the heaving) on the basis of the displacement of heaving, the pitching angle, and the rolling angle stored in the time history memory 22 in step S1 (step S6). The process of step S6 is a known technique and is thus not described here.

In step S6, on the basis of the time-series data of the displacement of heaving (unit: m), the pitching angle (unit: rad), the rolling angle (unit: rad), the hull state data calculation section 23 calculates for each frequency, cross spectra of the respective hull motions (the rolling, the pitching, and the heaving) including a rolling auto spectrum (unit: rad²/s), a pitching auto spectrum (unit: rad²/s), an heaving auto spectrum (unit: m²/s), a pitching-heaving cross spectrum (unit: rad·m/s), a rolling-heaving cross spectrum (unit: rad·m/s), and a pitching-rolling cross spectrum (unit: rad²/s). The cross spectra obtained for respective frequencies are stored as the time-series data in the time history memory 22.

If the process goes from steps S5 and S6 to step S7, the sea phenomena estimation section 24 probability statistically calculates a directional wave spectrum on the basis of the current hull response calculated in step S5 and the cross spectra of the respective hull motions (the rolling, the pitching, and the heaving) calculated in step S6 (step S7). Hereinafter, such process will be described together with a theory, used in step S7, according to the present embodiment.

If it is assumed that an ocean wave is represented by superposing component waves coming from every direction and having all frequencies, a sea surface variation amount η(t) at time t at an fixed point (vessel position) is expressed by Equation (8) below using a directional wave spectrum E(f, x) (unit: m²/(rad/s)). Note that, in Equation (8), the part under the root symbol and ε(f, x) are respectively the amplitude and the phase of a component wave having a frequency f coming from a direction x.

[Mathematical Expression 8]

η(t)=∫_{-π}^{π}∫₀^{on} cos{2πft+ε(f,x)}\sqrt{2E(f, x)dfdx} (8)

On the other hand, if it is assumed that the hull motion in wave responds linearly to an input wave, the directional wave spectrum E(fₑ, x) at an encounter frequency fₑ of one wave, and a cross spectrum φln(fₑ) of the hull motion in wave is express generally by Equation (9) below. Note that, in Equation (9), l and n are the modes of the hull motion in wave, and Hₗ(fₑ, x) and Hₙ*(fₑ, x) are respectively the response functions in the modes l and n. Further, x is an encounter angle with respect to a wave, and the symbol “*” represents a complex conjugate.

[Mathematical Expression 9]

Φᵢₙ(fₑ)=∫_{-π}^{π}Hₗ(fₑ, x)H*ₙ(fₑ, x)E(fₑ, x)dx (9)

Because Equation (9) is expressed based on the encounter frequency, this equation is converted into an equation based on an absolute frequency (see Equation (10) below).

$$\begin{matrix} [ Mathematical Expression 10 ] & \\ {φ}_{ln} ( {f}_{e} ) = {\int }_{\frac{π}{2}}^{π} {H}_{l} ( {f}_{01} , x ) {H}_{n}^{*} ( {f}_{01} , x ) E ( {f}_{01} , x ) \vert \frac{d {f}_{01}}{d {f}_{e}} \vert d x + {\int }_{- \frac{π}{2}}^{\frac{π}{2}} {H}_{l} ( {f}_{01} , x ) {H}_{n}^{*} ( {f}_{01} , x ) E ( {f}_{01} , x ) \vert \frac{d {f}_{01}}{d {f}_{e}} \vert d x ( {f}_{e} < \frac{1}{4 A} ) + {\int }_{- \frac{π}{2}}^{\frac{π}{2}} {H}_{l} ( {f}_{02} , x ) {H}_{n}^{*} ( {f}_{02} , x ) E ( {f}_{02} , x ) \vert \frac{d {f}_{02}}{d {f}_{e}} \vert d x ( {f}_{e} < \frac{1}{4 A} ) + {\int }_{- \frac{π}{2}}^{\frac{π}{2}} {H}_{l} ( {f}_{03} , x ) {H}_{n}^{*} ( {f}_{03} , x ) E ( {f}_{03} , x ) \vert \frac{d {f}_{03}}{d {f}_{e}} \vert d x + {\int }_{- π}^{- \frac{π}{2}} {H}_{l} ( {f}_{01} , x ) {H}_{n}^{*} ( {f}_{01} , x ) E ( {f}_{01} , x ) \vert \frac{d {f}_{01}}{d {f}_{e}} \vert d x & ( 10 )\end{matrix}$$

In Equation (10), the second to fourth terms on the right side represent contribution at a time of a following wave, in other words, represent the degree of the frequency component of the wave when running on the fallowing wave included in the cross spectrum. The parameter A, the three encounter frequencies f₀₁, f₀₂, and f₀₃ corresponding to the absolute frequency, and the Yacoubian are each defined as shown in Equation (11) below. Note that, in Equation (11), U is the vessel speed and g is the gravitational acceleration.

$$\begin{matrix}[ Mathematical Expression 11 ] & \\ \{ \begin{matrix}A = \frac{2 π}{g} U cos x \\ {f}_{01} = \frac{1 - \sqrt{1 - 4 {Af}_{e}}}{2 A} \\ {f}_{02} = \frac{1 + \sqrt{1 - 4 {Af}_{e}}}{2 A} \\ {f}_{03} = \frac{1 + \sqrt{1 + 4 {Af}_{e}}}{2 A} \\ \vert \frac{d {f}_{01}}{d {f}_{e}} \vert = \frac{1}{\sqrt{1 - 4 {Af}_{e}}} \\ \vert \frac{d {f}_{02}}{d {f}_{e}} \vert = \frac{1}{\sqrt{1 - 4 {Af}_{e}}} \\ \vert \frac{d {f}_{03}}{d {f}_{e}} \vert = \frac{1}{\sqrt{1 + 4 {Af}_{e}}}\end{matrix} & ( 11 )\end{matrix}$$

Here, in the case that the integration range with respect to the encounter angle x is divided into a sufficiently large number K of fine sections, the response function and the directional wave spectrum of a variation amount can be constant in each of the small sections. Therefore, Equation (10) can be discretized into Equation (12) below. Note that, in Equation (12), K1 (where, 0≦K1≦K/2) is the number of the fine sections which are in a following wave state in the discrete integration range.

$$\begin{matrix} [ Mathematical Expression 12 ] & \\ {φ}_{ln} ( {f}_{e} ) = Δ x {\sum }_{k = 1}^{K} {H}_{l , k} ( {f}_{01} ) {H}_{n , k}^{*} ( {f}_{01} ) {E}_{k} ( {f}_{01} ) + Δ x {\sum }_{k = 1}^{K 1} {H}_{l , k} ( {f}_{02} ) {H}_{n , k}^{*} ( {f}_{02} ) {E}_{k} ( {f}_{02} ) + Δ x {\sum }_{k = 1}^{K 1} {H}_{l , k} ( {f}_{03} ) {H}_{n , k}^{*} ( {f}_{03} ) {E}_{k} ( {f}_{03} ) \\ Where \\ \{ \begin{matrix}Δ x = 2 π / K \\ {E}_{k} ( {f}_{0 *} ) = {E}_{k} ( {f}_{0 *} , {x}_{k} ) \\ {x}_{k} = - π + ( k - 1 ) Δ x \\ {H}_{l , k} ( {f}_{0 *} ) = {H}_{l} ( {f}_{0 *} , {x}_{k} ) \\ {H}_{n , k}^{*} ( {f}_{0 *} ) = {H}_{n}^{*} ( {f}_{0 *} , {x}_{k} )\end{matrix} & ( 12 )\end{matrix}$$

Here, in the case that the pitching angle, the rolling angle, and the heaving displacement are respectively any given variation amounts θ, φ, and η, the cross spectrum Φ(fₑ) is a 3×3 matrix, and Equation (12) can be expressed in a matrix as Equation (13) below. Note that, in Equation (13), H(f₀₁) is a 3×K matrix, H(f₀₂) and H(f₀₃) are 3×K1 matrices, E(f₀₁) is K×K diagonal matrix, E(f₀2) and E(f₀₃) are K1×K1 diagonal matrices. Further, the symbol T represents a transposed matrix.

$$\begin{matrix} [ Mathematical Expression 13 ] & \\ Φ ( {f}_{e} ) = H ( {f}_{01} ) E ( {f}_{01} ) {H ( {f}_{01} )}^{* T} + H ( {f}_{02} ) E ( {f}_{02} ) {H ( {f}_{02} )}^{* T} + H ( {f}_{03} ) E ( {f}_{03} ) {H ( {f}_{03} )}^{* T} \\ Where \\ Φ ( {f}_{e} ) = ( \begin{matrix}{Φ}_{θθ} ( {f}_{e} ) & {Φ}_{θφ} ( {f}_{e} ) & {Φ}_{θη} ( {f}_{e} ) \\ {Φ}_{φθ} ( {f}_{e} ) & {Φ}_{φφ} ( {f}_{e} ) & {Φ}_{φη} ( {f}_{e} ) \\ {Φ}_{ηθ} ( {f}_{e} ) & {Φ}_{ηφ} ( {f}_{e} ) & {Φ}_{ηη} ( {f}_{e} )\end{matrix} ) \\ H ( {f}_{01} ) = ( \begin{matrix}{H}_{θ1} ( {f}_{01} ) & … & {H}_{θ K} ( {f}_{01} ) \\ {H}_{φ1} ( {f}_{01} ) & … & {H}_{φ K} ( {f}_{01} ) \\ {H}_{η1} ( {f}_{01} ) & … & {H}_{η K} ( {f}_{01} )\end{matrix} ) , \\ E ( {f}_{01} ) = ( \begin{matrix}{E}_{1} ( {f}_{01} ) & … & 0 \\ ⋮ & ⋱ & ⋮ \\ 0 & … & {E}_{K} ( {f}_{01} )\end{matrix} ) \\ H ( {f}_{0 i} ) = ( \begin{matrix}{H}_{θ1} ( {f}_{0 i} ) & … & {H}_{θ K 1} ( {f}_{0 i} ) \\ {H}_{φ1} ( {f}_{0 i} ) & … & {H}_{φ K 1} ( {f}_{0 i} ) \\ {H}_{η1} ( {f}_{0 i} ) & … & {H}_{η K 1} ( {f}_{0 i} )\end{matrix} ) , \\ E ( {f}_{0 i} ) = ( \begin{matrix}{E}_{1} ( {f}_{0 i} ) & … & 0 \\ ⋮ & ⋱ & ⋮ \\ 0 & … & {E}_{K 1} ( {f}_{0 i} )\end{matrix} ) i = 2 , 3 & ( 13 )\end{matrix}$$

Because the cross spectrum matrix Φ(fₑ) is an Hermitian matrix, it is enough to deal with the upper triangular matrix. Further, in the case that Equation (13) is expressed by separating the real part and the imaginary part and by introducing an error term W associated with observation, Equation (13) is expressed by a linear regression model represented by Equation (14) below.

[Mathematical Expression 14]

y=Ax+W (14)

In Equation (14), y is a vector constituted by the real part and the imaginary part of the cross spectrum matrix Φ(fₑ). The parameter A is a coefficient matrix constituted by a logical value of the response function of the hull motion in wave. The error term W is a white noise having a statistical characteristics of the average 0 and following a variance-covariance matrix Σ. The encounter angle x is an unknown vector constituted by the discretized directional wave spectrum.

In Equation (14), it is assumed that the cross spectrum is obtained in time series, the directional wave spectrum can be estimated in time series. This corresponds to considering Equation (14) as a time varying system, and Equation (14) can thus be extended into Equation (15) below, where time is represented by index t.

[Mathematical Expression 15]

yₜ=Aₜxₜ+Wₜ (15)

Equation (15) is formally equivalent to an observation model in a general state-space model. Therefore, by introducing as a system model a smoothing prior distribution, in which the directional wave spectrum changes smoothly with time, (see Equation (16) below), the problem of estimating the directional wave spectrum can be treated as a problem of the state estimation of the general state-space model shown by Equation (16) below.

$$\begin{matrix}[ Mathematical Expression 16 ] & \\ \{ \begin{matrix}{x}_{t} = {x}_{t - 1} + {v}_{t} \\ {y}_{t} = {A}_{t} {x}_{t} + {W}_{t}\end{matrix} & ( 16 )\end{matrix}$$

In Equation (16), xₜ is a state vector, vₜ is a system noise vector, yₜ is an observation vector, Aₜ is a state transition matrix, and Wₜ is an observation noise vector. Here, considering that the directional wave spectrum is not negative, the logarithm of the state vector xₜ is replaced anew by xₜ to deform Equation (16) into a general state-space model represented by Equation (17) below.

$$\begin{matrix}[ Mathematical Expression 17 ] & \\ \{ \begin{matrix}{x}_{t} = {x}_{t - 1} + {v}_{t} \\ {y}_{t} = {A}_{t} F ( {x}_{t} ) + {W}_{t}\end{matrix} & ( 17 )\end{matrix}$$

Here, F(xₜ) means that F(xₜ) is exponential to all the elements. Further, the elements of the state vector are configured as Equation (18) below.

$$\begin{matrix}[ Mathematical Expression 18 ] & \\ \{ \begin{matrix}F ( {x}_{t} ) = exp [ {x}_{t} ] \\ {x}_{l}^{T} = [ ln ( {x}_{1} , t ) , … , ln ( {x}_{J} , t ) ] \\ {F ( {x}_{t} )}^{T} = exp [ ln ( {x}_{1} , t ) , … , ln ( {x}_{J} , t ) ] \\ {x}_{j , t} = {E}_{k , t} ( {f}_{0 i} ) , i = 1 - m , j = 1 - J , J = m \times k , k = 1 - K .\end{matrix} & ( 18 )\end{matrix}$$

In Equation (18), m is the number of division of the absolute frequency. Equation (17) is a non-linear observation model, in other words, a non-linear state space model. Therefore, in order to estimate the state, it is necessary to use a method effective in non-linear filtering. Conventionally, a particle filter is used, but this filter has a very large calculation load. To address this issue, a state estimation method by using an Ensemble Kalman Filter is introduced in the present embodiment; however, an Ensemble Kalman Filter cannot be applied to Equation (17) in a non-linear observation model as it is. To solve this problem, the extended state vector represented by Equation (19) below is considered.

$$\begin{matrix}[ Mathematical Expression 19 ] & \\ {Z}_{i} = ( \begin{matrix}{x}_{t} \\ {A}_{t} F ( {x}_{t} )\end{matrix} ) & ( 19 )\end{matrix}$$

Further, the extended observation matrix and the extended state transition matrix represented by Equation (20) below are considered.

$$\begin{matrix}[ Mathematical Expression 20 ] & \\ \{ \begin{matrix}{\tilde{A}}_{t} = ( {O}_{l \times k} {I}_{l \times l} ) , \\ {\tilde{f}}_{t} ( {z}_{t - 1} , {v}_{t} ) = ( \begin{matrix}{x}_{t - 1} + {v}_{t} \\ {A}_{t} F ( {x}_{i - 1} + {v}_{i} )\end{matrix} )\end{matrix} & ( 20 )\end{matrix}$$

As a result, Equation (21) below holds for xₜ, and an extended system model is obtained. Further, regarding to yₜ, a formally linear extended observation model represented by Equation (22) below can be obtained. Because xₜ and yₜ are an extended state space model in the linear observation, the state estimation by an Ensemble Kalman Filter can be realized. Note that the application of the Ensemble Kalman Filter is a known technique and is thus not described here.

[Mathematical Expression 21]

zₜ=f̅ₜ(zₜ₋₁, vᵢ) (21)

[Mathematical Expression 22]

yₜ=Āₜzₜ+wₜ (22)

By the above-described process of step S7, the sea phenomena estimation section 24 probability statistically calculates the directional wave spectrum on the basis of the hull response calculated in step S5 and the cross spectra of the respective hull motions calculated in step S6 (step S7).

In the process of step S7, by probability statistically processing the hull response in a predetermined period from past to now and the time-series data of the cross spectra of the respective hull motions, the directional wave spectrum is calculated in real time. Thus, the directional wave spectrum with high accuracy can be derived.

Further, by this method, the directional wave spectrum is estimated on the basis of the state estimation by using the Ensemble Kalman Filter; thus, it is possible to estimate the directional wave spectrum with high accuracy in much shorter calculation time than in the method using the conventional Monte Carlo filter.

Note that when the process of step S7 has finished, the process goes to step S8, and the sea phenomena estimation section 24 estimates the sea conditions on the basis of the directional wave spectrum calculated in step S7 (step S8). In step S8, it is possible to estimate the sea conditions such as the wave direction, the wave cycle, the significant wave height, and the like in the local water in which the vessel is running, on the basis of the directional wave spectrum calculated in step S7.

An embodiment of the present invention is described above, but the above embodiment describes merely one of the application examples of the present invention. Therefore, it is not intended that the technical scope of the present invention is limited to the specific configuration of the above embodiment.

### REFERENCE SIGNS LIST

1: Sea phenomena estimation system
2: Satellite compass
3: Information processing device (Transverse metacenter height estimation device)
4: Display
21: Measurement section
22: Time history memory
23: Hull state data calculation section (Transverse metacenter height estimation section)
24: Sea phenomena estimation section
25: Output section

1. A transverse metacenter height estimation device, comprising:
a time history memory unit that stores time-series data of a rolling angle of a hull; and
a transverse metacenter height estimation unit that estimates a transverse metacenter height of the hull based on the time-series data of the rolling angle of the hull stored in the time history memory unit, wherein
the transverse metacenter height estimation unit calculates a rolling natural frequency based on the time-series data of the rolling angle of the hull, and estimates, while using the calculated rolling natural frequency as an observation model, the transverse metacenter height by performing state estimation based on a general state-space model in which the transverse metacenter height and a radius of gyration of the hull are state variables.

2. The transverse metacenter height estimation device according to claim 1, wherein the transverse metacenter height estimation unit estimates the transverse metacenter height GM by assuming a transverse metacenter height GMₙ at time n and a radius of gyration kn at time n as state variables in Equation (1) representing a relationship between the rolling natural frequency and the transverse metacenter height:
$$\begin{matrix}[ Mathematical Expression 1 ] & \\ T = \frac{1}{f} = \frac{2 π k}{\sqrt{gGM}} & ( 1 )\end{matrix}$$
where T is a rolling natural period, f is a rolling natural frequency, k is a radius of gyration, g is a gravitational acceleration, and GM is a transverse metacenter height, and
by performing state estimation based on a general state-space model which is represented by Equation (2):
$$\begin{matrix}[ Mathematical Expression 2 ] & \\ \{ \begin{matrix}{x}_{n} = {x}_{n - 1} + {v}_{n} \\ {T}_{n} = h ( {x}_{n} , {w}_{n} )\end{matrix} \\ Where \\ \{ \begin{matrix}{x}_{n} = {( {GM}_{n} {k}_{n} )}^{T} \\ {v}_{n} = {( {v}_{1 , n} {v}_{2 , n} )}^{T}\end{matrix} & ( 2 )\end{matrix}$$
where Vn is a system noise, Wn is an observation noise, and Tₙ is a rolling natural period and is observed data.

3. A transverse metacenter height estimation method comprising the steps of;
storing time-series data of a rolling angle of a hull in a time history memory; and
estimating a transverse metacenter height of the hull based on the time-series data of the rolling angle of the hull stored in the time history memory, wherein
in the step of estimating the transverse metacenter height of the hull, a rolling natural frequency is calculated based on the time-series data of the rolling angle of the hull, and
the transverse metacenter height is estimated, while the calculated rolling natural frequency is used as an observation model, by performing state estimation based on a general state-space model in which the transverse metacenter height and an radius of gyration of the hull are state variables.
